(19) United States
(12) Patent Application Publication
(10) Pub. No.: US 2024/0420015 A1
(43) Pub. Date: Dec. 19, 2024

(54) SYSTEMS AND METHODS FOR MACHINE LEARNING EVALUATION PIPELINE

(71) Applicant: WOVEN BY TOYOTA, INC., Tokyo (JP)

(72) Inventors: Daisuke HASHIMOTO, Tokyo (JP); Eiji NAKATSUGAWA, Tokyo (JP); Suigen KOIDE, Tokyo (JP)

(73) Assignee: WOVEN BY TOYOTA, INC., Tokyo (JP)

(21) Appl. No.: 18/335,450

(22) Filed: Jun. 15, 2023

(51) Int. Cl. G06N 20/00

(52) U.S. Cl. CPC G06N 20/00

(57) ABSTRACT

Provided are a method, system, and device for evaluating a machine learning (ML) model. The method may include: receiving, by a requirements management layer, at least one requirement obtained from a storage layer; interpreting, by the requirements management layer, the at least one requirement; and transmitting, by the requirements management layer, instructions to perform an ML evaluation process to an execution layer based on the interpreted requirements, wherein the execution layer transmits an output signal with the results of the ML evaluation process upon completing the ML evaluation process.

### TECHNICAL FIELD

Systems and methods consistent with example embodiments of the present disclosure relate to providing a pipeline for evaluating machine learning models.

### BACKGROUND

Machine learning (ML) models may be used to automate a variety of tasks. When developing an ML model, the developer may have certain criteria or parameters which need to be fulfilled by the ML model. For example, if the ML model intends to automate a safety-critical task, the ML model may need to achieve a certain reliability rating. Thus, in order to ensure that the ML model can meet the specifications, it may be necessary for the developer to test and evaluate the ML model by means of performing ML evaluation.

In the related art, simple metrics can be used to automatically determine whether the model is good or not. For example, a Mean Average Precision (mAP) may be used as a simple number to indicate whether or not the ML model is good, bad, or superior.

The process of evaluating ML models which is used by prior art systems and methods can be limiting and slow. In particular, typically, each component used in the ML evaluation process is separate. For example, the means to obtain the test data, the ML model itself, the ML evaluation test unit may all be in separate systems. Further, in the related art, each step in the evaluation process may require a human user to interpret the results of the ML evaluation, and consider how to repeat the evaluation process in order to obtain a more optimal ML model.

Accordingly, there is a need for a more streamlined and automated method to perform ML evaluation.

### SUMMARY

According to one or more example embodiments, apparatuses and methods are provided for evaluating machine learning (ML) models. In particular, apparatuses and methods according to example embodiments receive, at a requirements management layer, at least one requirement obtained from a storage layer, interpret, at the requirements management layer, the requirement, and transmit, by the requirements management layer instructions to perform an ML evaluation process to an execution layer based on the interpreted test parameters. The execution may transmit an output signal with the results of the ML evaluation process upon completing the ML evaluation process. Based on the output signal, the information of the results may be displayed in a user interface (UI). Accordingly, since the entire process of configuring and executing the ML evaluation process can be streamlined/encapsulated in a single pipeline and optionally presented to the user with a user interface which is connected to layer(s) of the pipeline, automation of the evaluation process can be improved.

According to an embodiment, a method for evaluating a ML model may be provided. The method may include: receiving, by a requirements management layer, at least one requirement obtained from a storage layer; interpreting, by the requirements management layer, the at least one requirement; and transmitting, by the requirements management layer, instructions to perform an ML evaluation process to an execution layer based on the interpreted test parameters, wherein the execution layer transmits an output signal with the results of the ML evaluation process upon completing the ML evaluation process.

The at least one test parameter may be in the form of a requirements as code (RaC) file.

The storage layer may be in communication with a first user interface configured to allow a user to edit the at least one test parameter.

The execution layer may be configured to transmit the output signal to a second user interface configured to display the results of the ML evaluation process.

The first user interface and the second user interface may be displayed simultaneously.

The execution layer may include an inference component and a unit test component, wherein upon receiving the instructions to perform an ML evaluation process, the inference component is configured to receive test data and perform an inference process based on the test data and instructions to obtain an output from the ML model, and the unit test component is configured to perform an evaluation process based on the output from the ML model and the instructions to obtain metrics.

The inference component may be configured to receive the test data from a test data storage layer.

According to an embodiment, an apparatus for evaluating a machine learning (ML) model, may be provided. The apparatus may include: at least one memory storing computer-executable instructions; and at least one processor configured to execute the computer-executable instructions to: receive, by a requirements management layer, at least one requirement obtained from a storage layer; interpret, by the requirements management layer, the at least one requirement, and transmit, by the requirements management layer, instructions to perform an ML evaluation process to an execution layer based on the interpreted requirements, wherein the execution layer transmits an output signal with the results of the ML evaluation process upon completing the ML evaluation process.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a system architecture diagram showing the layers and components according to one or more example embodiments;

FIG. 3 is a flowchart diagram showing a method for evaluating a ML model according to one or more example embodiments;

FIG. 4 is a flowchart diagram showing a method for evaluating a ML model using an inference and unit test component according to one or more example embodiments; and

FIG. 5 is a flowchart diagram showing a method for evaluating a ML model including adding or updating requirements according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

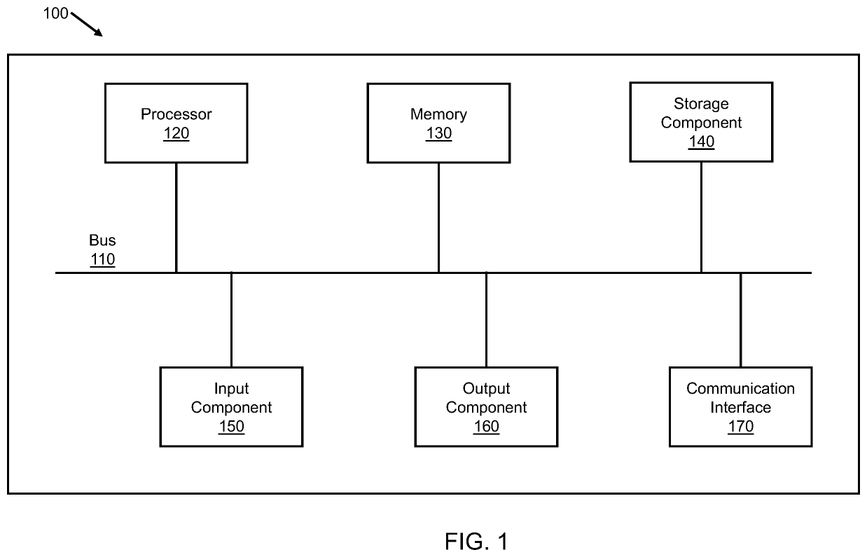

FIG. 1 is a diagram of example components of a machine learning (ML) evaluation device 100. As shown in FIG. 1, ML evaluation device 100 may include a bus 110, a processor 120, a memory 130, a storage component 140, an input component 150, an output component 160, and a communication interface 170.

Bus 110 includes a component that permits communication among the components of ML evaluation device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of ML evaluation device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits ML evaluation device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from ML evaluation device 100 (e.g., a display, a speaker, and/or one or more light-emitting diodes (LEDs)).

The communication interface 170 includes a transceiver-like component (e.g., a transceiver and/or a separate receiver and transmitter) that enables ML evaluation device 100 to communicate with other devices, such as via a wired connection, a wireless connection, or a combination of wired and wireless connections. The communication interface 170 may permit the ML evaluation device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The ML evaluation device 100 may perform one or more example processes described herein. According to one or more example embodiments, the ML evaluation device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the ML evaluation device 100 may include additional components, fewer components, different components, or differently arranged components than those shown in FIG. 1. Additionally, or alternatively, a set of components (e.g., one or more components) of the ML evaluation device 100 may perform one or more functions described as being performed by another set of components of the ML evaluation device 100.

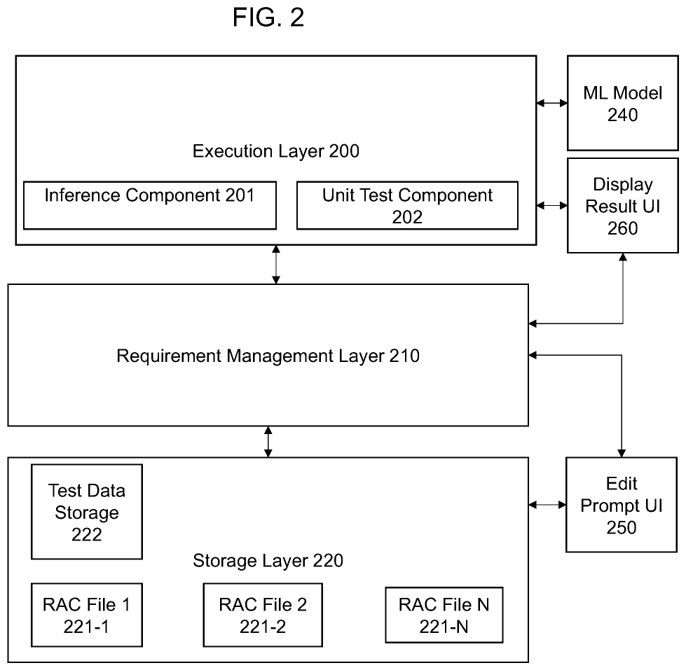

FIG. 2 is a system architecture diagram showing the layers and components according to one or more example embodiments. In combination, the layers (e.g., execution layer 200, requirement management layer 210, and storage layer 220) may be considered as a machine learning (ML) evaluation pipeline.

According to embodiments, execution layer 200 may be provided. Execution layer 200 may contain an inference component 201 and a unit test component 202. Execution layer 200 may be responsible for executing the ML evaluation process on ML model 240. It should be appreciated that execution layer 200 may implement any appropriate means for executing ML evaluation. Execution layer 200 may be configured to receive instructions from requirement management layer 210. Execution layer 200 may also interact with display result UI 260 in order to output the result of the evaluation. In particular, execution layer 200 may transmit an output signal upon completing the evaluation containing the results of the evaluation, and according to some embodiments, display result UI 260 may receive the output signal to display the results of the evaluation. Display result UI 260 may be implemented with any appropriate UI. For example, display result UI 260 may have a tabular format to list the results of the evaluation test, and it may highlight specific portions of the test results based on whether it passed or failed. Nevertheless, it should be appreciated that display UI 260 may depend on the specific implementation, as will be determined by a person skilled in the art.

Execution layer 200 may also receive test data from test data storage 222, either via requirement management layer 210, or directly from test data storage 222.

According to some embodiments, inference component 201 may be responsible for receiving the data from test data storage 222, and inputting the data into ML model 240 to calculate an output using ML model 240 (i.e., inference).

According to some embodiments, unit test component 202 may be responsible for performing a unit test on ML model 240. Specifically, the unit test may evaluate the result of the output from the ML model 240 obtained during the inference process performed using inference component 201 on ML model 240. Metrics about the performance of the ML model 240 may be obtained using unit test component 202.

Requirements management layer 210 may be provided. Requirements management layer 210 may be responsible for interpreting the files stored in the storage layer (such as Requirements as Code (RAC) files 1, 2 . . . . N (221-1, 221-2, 221-N . . . )) or the test data from test data storage 222. Based on the interpretation of the RAC files, requirement management layer 210 may send instructions to execution layer 200 to execute the ML evaluation.

Storage layer 220 may contain all the data which is used by execution layer 200 and requirement management layer 210. Storage layer 220 may be implemented by any appropriate storage means (e.g., a database, cloud storage, etc.). Storage layer 220 may contain any number of RAC files 221-1, 221-2, 221-N, and test data storage 222. It should be appreciated that each RAC file and test data storage may be stored in the same storage medium, or different storage mediums.

Requirements as Code (RAC) files 221-1, 221-2, 221-N may be responsible for storing expected behaviors of ML Model 240. The expected behaviors may comprise the requirements (which may include test parameters). In particular, the RAC files may be in a human readable format which specify what the performance metrics of the ML model which need to be tested, for example, based on a specific metric criteria which needs to be achieved, a standard which needs to be achieved, a type of test, etc. The RAC files may include requirements, pass criteria, test targets, file paths of test data, test conditions which are to be used during the ML evaluation process in execution layer 200. Accordingly, such requirements, pass criteria, test targets, test data paths, and test conditions may be readily interpreted by requirement management layer 210 in order to determine how the ML testing and evaluation of ML model 240 should be executed by execution layer 200.

According to some embodiments, RAC files 221-1, 221-2, 221-N may be editable by Edit Prompt UI 250. In particular, Edit Prompt UI 250 may either be a generic command line interface used to edit the source files, or it may be a graphical user interface (GUI) with interactable elements to allow the user to drag and drop or select pre-determined configurations. Nevertheless, it should be appreciated that any appropriate user interface may be implemented for edit prompt UI 250.

Test data storage 222 may contain the data which will be used by inference component 201 to input into ML model 240. Test data storage 222 may be stored separately from the RAC files according to some embodiments. The specific format of the data files for the test data may be any appropriate format.

It should be appreciated that edit prompt UI 250 and display result UI 260 may be implemented in any appropriate environment, for example, in a web interface, or on the local user device only. It should also be appreciated that according to some embodiments, edit prompt UI 250 and display result UI 260 may be displayed either separately, or simultaneously.

According to an embodiment, a UI (which may include features of edit prompt UI 250 and display result UI 260) may be provided which may include further features to streamline the evaluation process. For example, the user interface may be in communication with the requirement manager layer 210, along with an interface to allow the user to choose which set(s) of requirements from the storage layer 220 should be used and their sequencing, for example, whether a first set and second set of requirements should be evaluated sequentially, or in parallel. Said user interface may also allow the user to select the test data set (for example, from test data storage 222). It is also contemplated that the user may be able to configure the same set(s) of requirements to be run across different candidate ML models, and automatically indicate which candidate ML model has the highest metrics.

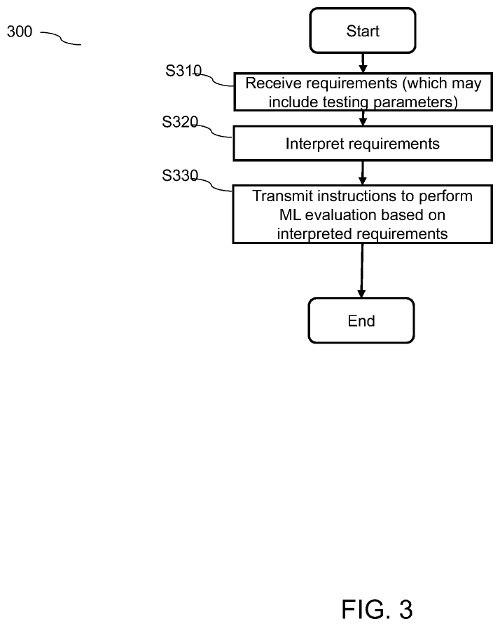

FIG. 3 is a flowchart diagram showing a method 300 for evaluating a ML model according to one or more example embodiments.

Referring to FIG. 3, at operation S310, requirements including test parameters are received by requirement management layer 210 from storage layer 220. According to some embodiments, the requirements, (such as test parameters) may be one or more of RAC files 221-1, 221-2, 221-N.

At operation S320, after receiving the requirements from the storage layer 220, the requirements may be interpreted by requirement management layer 210 in order to determine how to instruct the execution layer 200 to perform the ML evaluation on ML model 240. This may include interpreting the requirements, pass criteria, test targets, test data path, model tuning parameters such as confidence thresholds, test conditions from the requirements, and determining the appropriate tests and testing parameters that should be done using execution layer 200. Accordingly, interpreted requirements may be obtained by requirement management layer 210

At operation S330, the requirement management layer 210 transmits instructions, based on the interpreted testing parameters from operation S320 to execution layer 200 in order to have the execution layer 200 perform the ML evaluation on ML model 240. According to some embodiments, once execution layer 200 is done performing the ML evaluation, it may transmit an output signal containing the results of the evaluation. According to some embodiments, this output signal may be sent to display result UI 260.

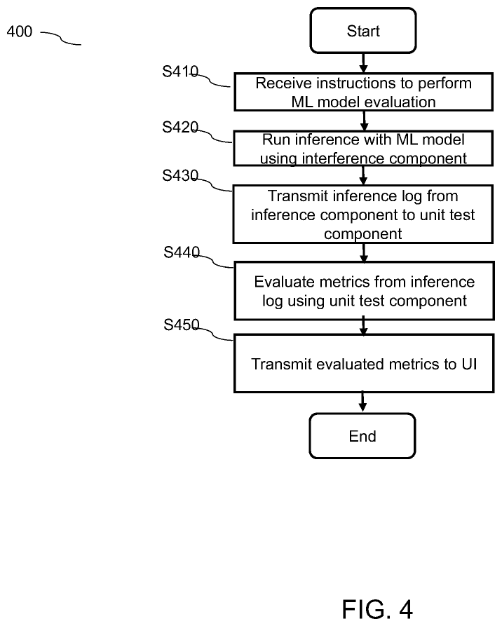

FIG. 4 is a flowchart diagram showing a method 400 for evaluating a ML model using an inference and unit test component according to one or more example embodiments. The similar layers and components illustrated in FIG. 2 may be used to implement method 400, and the full description of similar steps from method 300 as illustrated in FIG. 3 may be omitted for readability.

Referring to FIG. 4, at operation S410, instructions to perform an ML evaluation may be transmitted from requirement management layer 210, and received by execution layer 200 in order to have the execution layer 200 perform the ML evaluation on ML model 240. The instruction received in operation S410 may be similar to the one sent in operation S330 as described in FIG. 3 above.

At operation S420, execution layer 200 may send an instruction to inference component 201 to run an inference operation using ML model 240, with test data (e.g., test data obtained from test data storage 222). The output of this operation may include an inference log, which may include data from running an inference operation on ML model 240 using the test data.

At operation S430, execution layer 200 may transmit the inference log from inference component 201, to unit test component 202.

At operation S440, execution layer 200 may send an instruction to unit test component 202 to evaluate the metrics (e.g., by calculating and comparing the metrics with test criteria from the requirements).

At operation S450, execution layer 200 may output the evaluated metrics (which may include the comparison results). According to some embodiments, this may include transmitting the metrics and comparison results to a UI, such as display result UI 260.

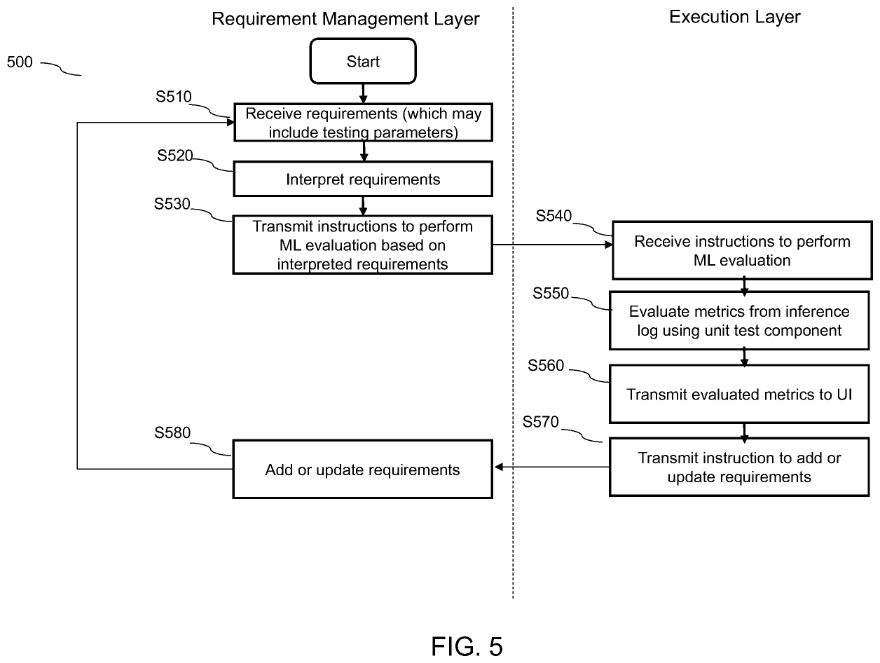

FIG. 5 is a flowchart diagram showing a method for evaluating a ML model including adding or updating requirements according to one or more example embodiments. The similar layers and components illustrated in FIG. 2 may be used to implement method 500, and the full description of similar steps from method 300 as illustrated in FIG. 3 and method 400 as illustrated in FIG. 4 above may be omitted for readability

Referring to FIG. 5, at operation S510, requirements including test parameters are received by requirement management layer 210 from storage layer 220. This may be similar to operation S310 described in FIG. 3 above.

At operation S520, after receiving the requirements from the storage layer 220, the requirements may be interpreted by requirement management layer 210 in order to determine how to instruct the execution layer 200 to perform the ML evaluation on ML model 240. This may be similar to operation S320 described in FIG. 3 above

At operation S530, the requirement management layer 210 transmits instructions, based on the interpreted testing parameters from operation S320 to execution layer 200 in order to have the execution layer 200 perform the ML evaluation on ML model 240. This may be similar to operation S330 described in FIG. 3 above.

At operation S540, instructions to perform an ML evaluation may be received by execution layer 200 in order to have the execution layer 200 perform the ML evaluation on ML model 240. This may be similar to operation S410 described in FIG. 4 above.

At operation S550, instructions execution layer 200 may send an instruction to unit test component 202 to evaluate metrics (e.g., by calculating and comparing the metrics with test criteria from the requirements). This may be similar to operation S440 described in FIG. 4 above. It should be appreciated that although not explicitly illustrated, according to some embodiments, operations similar to S420-S430 may also be included prior to operation S550.

At operation S560, execution layer 200 may output the evaluated metrics (which may include the comparison results) and transmitting the metrics and comparison results to a UI, such as display result UI 260. This may be similar to operation S450 described in FIG. 4 above.

At operation S570, execution layer 200 may transmit an instruction to requirement management layer 210, to add requirements to storage layer 200 (for example, by adding a new RAC file to storage layer 220), or to update existing requirements (for example, by editing an existing RAC file in storage layer 220). The instruction may be transmitted in order to update ML model tuning parameters, such as, but not limited to, confidence thresholds and test parameters for optimizing overall performance of the system, including ML Model 240.

At operation S580, requirement management layer 210 receives the instructions transmitted in operation S570, and adds or updates the requirements in storage layer 220 accordingly. Thereafter, the steps may be repeated from S510. According to this embodiment, an iterative process for exploring requirements and parameters which may have not yet been discovered may be implemented.

Based on the above embodiments, it can be understood that since the entire process of configuring and executing the ML evaluation process can be streamlined/encapsulated in a single pipeline and optionally presented to the user with a user interface which is connected to layer(s) of the pipeline, automation of the evaluation process can be improved.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for evaluating a machine learning (ML) model, the method comprising:
receiving, by a requirements management layer, at least one requirement obtained from a storage layer;
interpreting, by the requirements management layer, the at least one requirement; and
transmitting, by the requirements management layer, instructions to perform an ML evaluation process to an execution layer based on the interpreted requirements, wherein the execution layer transmits an output signal with the results of the ML evaluation process upon completing the ML evaluation process.

2. The method according to claim 1, wherein the at least one requirement is in the form of a requirements as code (RaC) file.

3. The method according to claim 1, wherein the storage layer is in communication with a first user interface configured to allow a user to edit the at least one requirement.

4. The method according to claim 3, wherein the execution layer is configured to transmit the output signal to a second user interface configured to display the results of the ML evaluation process.

5. The method according to claim 4, wherein the execution layer comprises an inference component and a unit test component, wherein upon receiving the instructions to perform an ML evaluation process, the inference component is configured to receive test data and perform an inference process based on the test data and instructions to obtain an output from the ML model, and the unit test component is configured to perform an evaluation process based on the output from the ML model and the instructions to obtain metrics.

6. The method according to claim 5, wherein the output from the ML model comprises an inference log, and wherein upon completing the inference process, the inference component is configured to transfer the inference log to the unit test component, wherein the evaluation process comprises evaluating metrics from the inference log, wherein the evaluated metrics are displayed in the second user interface.

7. The method according to claim 6, wherein the method further comprises:
receiving, by the requirements management layer, an instruction to add or update at least one requirement in the storage layer, wherein the instruction is transmitted from the execution layer based on the evaluated metrics and upon completing the ML evaluation process.

8. An apparatus for evaluating a machine learning (ML) model, the apparatus comprising:
at least one memory storing computer-executable instructions; and
at least one processor configured to execute the computer-executable instructions to:
receive, by a requirements management layer, at least one requirement obtained from a storage layer;
interpret, by the requirements management layer, the at least one requirement; and
transmit, by the requirements management layer, instructions to perform an ML evaluation process to an execution layer based on the interpreted requirements, wherein the execution layer transmits an output signal with the results of the ML evaluation process upon completing the ML evaluation process.

9. The apparatus according to claim 8, wherein the at least one requirement is in the form of a requirements as code (RaC) file.

10. The apparatus according to claim 8, wherein the storage layer is in communication with a first user interface configured to allow a user to edit the at least one requirement.

11. The apparatus according to claim 10, wherein the execution layer is configured to transmit the output signal to a second user interface configured to display the results of the ML evaluation process.

12. The apparatus according to claim 11, wherein the execution layer comprises an inference component and a unit test component, wherein upon receiving the instructions to perform an ML evaluation process, the inference component is configured to receive test data and perform an inference process based on the test data and instructions to obtain an output from the ML model, and the unit test component is configured to perform an evaluation process based on the output from the ML model and the instructions to obtain metrics.

13. The apparatus according to claim 12, wherein the output from the ML model comprises an inference log, and wherein upon completing the inference process, the inference component is configured to transfer the inference log to the unit test component, wherein the evaluation process comprises evaluating metrics from the inference log, wherein the evaluated metrics are displayed in the second user interface.

14. The apparatus according to claim 13, wherein the processor is further configured to execute the computer-executable instructions to:
receive, by the requirements management layer, an instruction to add or update at least one requirement in the storage layer, wherein the instruction is transmitted from the execution layer based on the evaluated metrics and upon completing the ML evaluation process.

15. A non-transitory computer-readable recording medium having recorded thereon instructions executable by at least one processor to cause the processor to perform a method comprising:
receiving, by a requirements management layer, at least one requirement obtained from a storage layer;
interpreting, by the requirements management layer, the at least one requirement; and
transmitting, by the requirements management layer, instructions to perform an ML evaluation process to an execution layer based on the interpreted requirements, wherein the execution layer transmits an output signal with the results of the ML evaluation process upon completing the ML evaluation process.

16. The non-transitory computer-readable recording medium according to claim 1, wherein the at least one requirement is in the form of a requirements as code (RaC) file.

17. The non-transitory computer-readable recording medium according to claim 15, wherein the storage layer is in communication with a first user interface configured to allow a user to edit the at least one requirement.

18. The non-transitory computer-readable recording medium according to claim 17, wherein the execution layer is configured to transmit the output signal to a second user interface configured to display the results of the ML evaluation process.

19. The non-transitory computer-readable recording medium according to claim 18, wherein the execution layer comprises an inference component and a unit test component, wherein upon receiving the instructions to perform an ML evaluation process, the inference component is configured to receive test data and perform an inference process based on the test data and instructions to obtain an output from the ML model, and the unit test component is configured to perform an evaluation process based on the output from the ML model and the instructions to obtain metrics.

20. The non-transitory computer-readable recording medium according to claim 19, wherein the output from the ML model comprises an inference log, and wherein upon completing the inference process, the inference component is configured to transfer the inference log to the unit test component, wherein the evaluation process comprises evaluating metrics from the inference log, wherein the evaluated metrics are displayed in the second user interface.
